(19) United States
(12) Patent Application Publication
(10) Pub. No.: US 2007/0217985 A1
(43) Pub. Date: Sep. 20, 2007

(54) Method of removing nitrogen oxides from flue gases

(76) Inventors: Franz Beran, Munchen (DE); Dieter Kaufmann, Geretsried (DE); Gerhard Merz, Baierbrunn (DE); Nicole Schodel, Munchen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/724,334

(22) Filed: Mar. 15, 2007

(30) Foreign Application Priority Data
Mar. 16, 2006 (DE) 10 2006 012 206.2

(51) Int. Cl. B01D 53/86

(52) U.S. Cl. 423/239.1

(57) ABSTRACT

For the catalytic removal of nitrogen oxides (2) from flue gases of combustion furnaces (1) which use hydrogen (H₂) is used as reducing agent and the reaction is conducted at a temperature of below 150° C.

### METHOD OF REMOVING NITROGEN OXIDES FROM FLUE GASES

This invention relates to a method for the selective catalytic removal of nitrogen oxides from oxygen-containing flue gas of combustion furnaces in the presence of a reducing agent.

In the combustion of fossil fuels such as coal, gas or oil, flue gases which contain nitrogen oxides are formed. These nitrogen oxides are harmful to humans (irritation or damage to the respiratory organs) and are one of the main causes of acid rain, smog formation and ozone formation in the presence of UV radiation. Therefore, removal as complete as possible of the nitrogen oxides from the flue gas before it escapes into the atmosphere is desirable. In the course of EU directives on the nitrogen oxygen content in flue gases which are becoming stricter, the use of up-to-date methods for removing nitrogen oxides is an economically interesting field also in the field of retrofitting relatively old industrial plants.

In the prior art, the nitrogen oxides (NOₓ) in the flue gas are catalytically reacted to form nitrogen and water in the selective catalytic reduction method by contacting them with a catalyst (DeNOx catalyst) in the presence of a reducing agent. As reducing agent, in the prior art use is made of ammonia which can be provided in different forms (gaseous, in aqueous solution, or by the conversion of corresponding compounds such as urea). The catalytic conversion is carried out in the prior art in a temperature range between 250° C. and 500° C. (for example patent: WO 02/068097 A1). In order to operate the catalyst in this temperature range, for example in the cracking furnaces of an olefin plant, it can either be mounted between the heat exchangers in the region of the exhaust heat, or, when it is mounted at the cold end of the flue gas outlet at temperatures of below 150° C., it must be equipped with additional heating of the flue gas. In both cases, retrofitting existing plants is difficult, complex and expensive. Introducing the catalyst into the waste heat of the cracking furnace between the heat exchangers requires relatively extensive conversion measures connected with relatively long idle times of the plant. The catalyst system can only be positioned at the bottom at the cold end of the waste heat, on account of the increase in weight due to the system and due to the additional flue gas heating, which requires additional pipework connected with more extensive conversion measures.

In addition to the above-described methods in the temperature range between 250° C. and 500° C., what are termed low-temperature methods exist which likewise use ammonia as the reducing agent and also can be used in the temperature range between 120° C. and 350° C. (C. J. G. von der Grift, A. F. Woldhuis, O. L. Maaskant, Catalysis Today 27, 23-27 (1996)). The use of such methods in a temperature range below 150° C., however, is only possible in individual cases. The flue gas must be free from dust and sulphur contents. Sulphur in the flue gas, in the presence of ammonia, and at temperatures below 150° C., forms ammonium sulphate which deactivates the catalyst, as do salts (NH₄NO₃, NH₄NO₂) forming below a certain temperature. In addition, the conversion of nitrogen oxides decreases in the low-temperature range (70% NOₓ conversion at 140° C., from C. J. G. von der Grift, A. F. Woldhuis, O. L. Maaskant, Catalysis Today 27, 23-27 (1996)). Therefore, the existing low-temperature methods are likewise unsuitable for retrofitting combustion furnaces in relatively old plants.

Typical catalysts for the removal of nitrogen oxides at higher temperatures (250° C.-500° C.°) are vanadium, titanium or cerium on a ceramic honeycomb. The range of possible catalysts for the standard high temperature methods is given in the cited patent application WO 02/068097. The so called low temperature method uses a V₂O₅—TiO₂/SiO₂ on porous particles (extrudates) with a diameter of approximately 1 mm. Both systems work with ammonia as the reducing agent.

One object of the present invention is to provide a method apparatus for the selective catalytic removal of nitrogen oxides from oxygen-containing flue gas from combustion furnaces in the presence of a reducing agent in such a manner that combustion furnaces in existing plants can be simply and inexpensively retrofitted.

Upon further study of the application and appended claims, other objects and advantages will become apparent.

These objects are achieved by using hydrogen as the reducing agent at a temperature below 150° C. Accordingly, there are avoided difficulties in retrofitting combustion furnaces in existing plants resulting from the necessity of carrying out the catalytic method for nitrogen oxide removal at temperatures above 150° C.

By using hydrogen as the reducing agent, it is possible to carry out the catalytic removal of the nitrogen oxides at temperatures corresponding to the outlet temperature of flue gas from combustion furnaces of the prior art at below 150° C.

According to a particularly preferred embodiment of the invention, the removal of nitrogen oxides from the flue gas proceeds by the conversion of nitrogen oxides into nitrogen and water by the reducing agent hydrogen in the presence of a suitable catalyst. Advantageously, the method is carried out at a temperature of below 150° C. The catalytic removal takes place preferably in the cold end of the waste heat of the combustion furnace.

In a further embodiment, the catalytic removal of nitrogen oxides from the flue gases is carried out downstream of the waste heat in a separate reactor. Advantageously, in a further embodiment of the invention, in plants having at least two combustion furnaces, the flue gases of a plurality of combustion furnaces are combined and together are freed from nitrogen oxides in a separate reactor.

In an additional embodiment of the invention, in combustion furnaces in olefin plants, hydrogen plants, synthesis gas plants or similar plants in which hydrogen is obligatorily present as process gas, this hydrogen is used as reducing agent for nitrogen oxide removal. According to a development of the inventive concept, the hydrogen, after removal of the nitrogen oxides, can be cleaned up by a membrane separation and/or a pressure-swing adsorption method, further processed and/or fed to the nitrogen oxide removal.

By means of the invention, in particular by using hydrogen as reducing agent and the associated possibility of carrying out the method at a temperature below 150° C., it is possible to retrofit combustion furnaces in existing plants simply and inexpensively. In addition, operating the method in combustion furnaces in olefin plants, hydrogen plants, synthesis gas plants, or in similar plants in which hydrogen is present as process gas is simple and inexpensive.

Operating Conditions

As the catalyst to be used in the present invention where H₂ is the reducing agent, it is preferred to employ a platinum catalyst on a MgO—CeO₂ substrate. Nevertheless, it is contemplated that other well known catalysts employed in hydrogen reduction reaction can also be employed, for example any catalyst comprising platinum or palladium on a substrate.

In general the following conditions are applicable:

| | | Preferred |
|---|---|---|
| | Range | Range |
| Catalyst volume- | 40,000-160,000 l/h | 40,000-100,000 l/h |
| related flue gas | | |
| velocity: | | |
| Temperature: | 120-150° C. | 135-145° C. |
| NOₓ: | 75-2500 ppmV | — |
| O₂: | 1.7-5.5% by | — |
| | volume | |
| H₂: | 500-10,000 ppmV | — |
| NOₓ conversion: | 80-99% | — |

The invention will be described in more detail hereinafter on the basis of the embodiments of the invention shown in the figures.

### BRIEF DESCRIPTION OF DRAWINGS

In the Drawings

FIG. 1 shows an embodiment of the invention with the catalytic removal of the nitrogen oxides carried out at the end of the flue gas channel

FIG. 2 shows an embodiment of the invention having two combustion furnaces and the joint catalytic removal of the nitrogen oxides for both combustion furnaces.

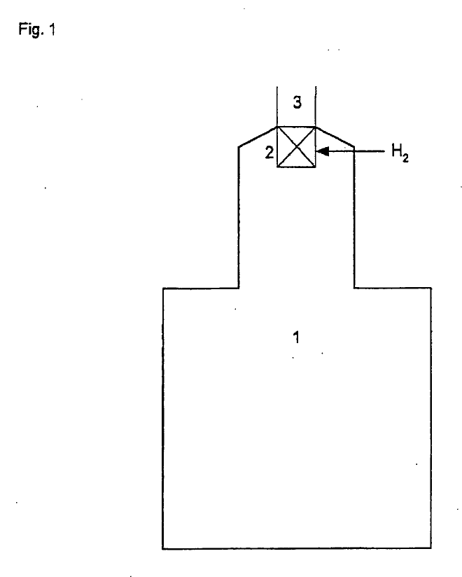

FIG. 1 shows an embodiment of the invention in which the catalytic reaction of the nitrogen oxides with hydrogen as reducing agent (H₂) proceeds directly at the end of the flue gas channel (2) of the combustion furnace (1). The catalytic removal of the nitrogen oxides is integrated directly into the combustion furnace. The purified flue gas is discharged into the atmosphere (3).

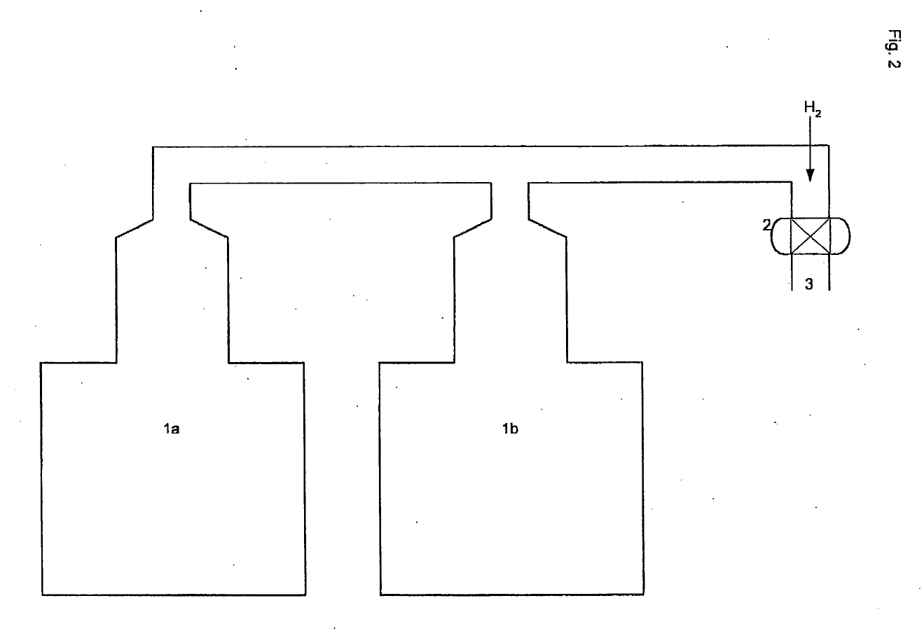

FIG. 2 shows a further embodiment of the invention in which the flue gases produced in the two combustion furnaces (1a) and (1b) are collected. The catalytic removal of the nitrogen oxides using hydrogen as reducing agent (H₂) is performed for the entire flue gas in a separate reactor (2) at the end of the exhaust gas lines. The purified flue gas is subsequently discharged into the atmosphere (3).

### EXAMPLE

Removal of nitrogen oxides from the flue gas of an experimental furnace by catalytic conversion using hydrogen as reducing agent:

| Feed: | Catalyst volume-related flue | 80 000 l/hour |
|---|---|---|
| | gas velocity: | |
| | Temperature: | 142° C. |
| | NOₓ: | 150 ppmV |
| | O₂: | 2.5 percent |
| | | by volume |
| | H₂: | 2000 ppmV |
| | H₂O: | 10% by volume |
| Conversion: | NOₓ: | 91% |

The preceding examples can be repeated with similar success by substituting the generically or specifically described reactants and/or operating conditions of this invention for those used in the preceding examples.

The entire disclosures of all applications, patents and publications, cited herein and of corresponding German application No. 10 2006 012 206.2, filed Mar. 16, 2006 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. In a method for the selective catalytic removal of nitrogen oxides from oxygen-containing flue gas of a combustion furnace in the presence of a reducing agent, the improvement wherein the reducing agent is hydrogen, and the catalytic removal is conducted at a temperature below 150° C. in contact with a hydrogen reduction catalyst.

2. A method according to claim 1, wherein the catalytic removal of the nitrogen oxides is carried out directly at an exit waste heat flue of the combustion furnace.

3. A method according to claim 1, wherein the catalytic removal of the nitrogen oxides is conducted in a separate reactor downstream of the waste heat flue.

4. A method according to claim 1, wherein flue gases of at least two combustion furnaces are combined and together are freed from nitrogen oxides.

5. A method according to claim 1, wherein in at least one combustion furnace in an olefin plant, a hydrogen plant, or a synthesis gas plant in which hydrogen is a process gas, and the latter hydrogen is used as the reducing agent for nitrogen oxide removal.

6. A method according to claim 5, wherein the hydrogen used as reducing agent is cleaned up downstream of the catalytic nitrogen oxide removal via a membrane method and/or a pressure-swing adsorption method, reused and/or fed to the nitrogen oxide removal.

7. A method according to claim 1, conducted under the following operating conditions

| | Range |
|---|---|
| Catalyst volume- | 40,000-160,000 l/h |
| related flue gas | |
| velocity: | |
| Temperature: | 120-150° C. |
| NOₓ: | 75-2500 ppmV |
| O₂: | 1.7-5.5% by |
| | volume |
| H₂: | 500-10,000 ppmV |
| NOₓ conversion: | 80-99% |

8. A method according to claim 7, conducted at 135-145° C.

9. A method according to claim 7, wherein said catalyst volume-related flue gas velocity is 40,000-100,000 l/h.

10. A method according to claim 8, wherein said catalyst volume-related flue gas velocity is 40,000-100,000 l/h.

11. A method according to claim 7, wherein the catalyst comprises platinum or palladium on a substrate.

12. A method according to claim 7, wherein the catalyst comprises platinum on a substrate.

13. A method according to claim 12, wherein the substrate comprises MgO—CeO.

14. A method according to claim 10, wherein the catalyst comprise platinum on a substrate.

15. A method according to claim 14, wherein the substrate comprises MgO—CeO.

16. A method according to claim 15, wherein the catalytic removal of the nitrogen oxides is carried out directly at an exit waste heat flue of the combustion furnace.

17. An integrated plant comprising means for providing hydrogen, a combustion chamber, means for containing catalyst located downstream and integral with said combustion chamber and conduit means connecting said means for producing hydrogen with said means for containing catalyst.
